(19) United States
(12) Patent Application Publication
(10) Pub. No.: US 2026/0004947 A1
(43) Pub. Date: Jan. 1, 2026

(54) WIRE HARNESS

(71) Applicant: SUMITOMO WIRING SYSTEMS, LTD., Yokkaichi-shi (JP)

(72) Inventor: Miyu MIZUTANI, Yokkaichi-shi (JP)

(73) Assignee: SUMITOMO WIRING SYSTEMS, LTD., Yokkaichi-shi (JP)

(21) Appl. No.: 19/252,948

(22) Filed: Jun. 27, 2025

(30) Foreign Application Priority Data
Jun. 27, 2024 (JP) 2024-103960

(51) Int. Cl. H01B 7/00; B60R 16/02; H01R 13/58

(52) U.S. Cl. CPC H01B 7/0045; B60R 16/0215; H01R 13/5833

(57) ABSTRACT

A wire harness that includes: an electric wire; a protector that stores part of the electric wire in a length direction; and a connector provided at one end of the electric wire led out from the protector, wherein the protector includes: a first lead-out port and a second lead-out port from each of which the electric wire is led out; an electric wire fixing portion to which the electric wire is fixed; a main storage that is provided between the electric wire fixing portion and the first lead-out port and that stores the electric wire; and an extra length storage that is provided between the electric wire fixing portion and the second lead-out port and that is capable of storing an extra length of the electric wire.

### BACKGROUND

The present disclosure relates to a wire harness.

For example, JP 2019-146289A describes a wire harness including: an electric wire; a protector that stores part of the electric wire in the length direction; and a connector provided at the end of the electric wire led out from the protector. The protector includes an electric wire fixing portion to which the electric wire is fixed, at the part where the electric wire is led out to the outside. The connector is provided at the tip of the electric wire drawn out of the protector from the electric wire fixing portion. The connector is connected to a mating connector.

### SUMMARY

With the wire harness described above, the connection work of connecting the connector to the mating connector may be difficult depending on the positional relationship between the electric wire fixing portion in the protector and the mating connector, such as when the distance from the electric wire fixing portion to the mating connector is short.

An exemplary aspect of the disclosure provides a wire harness that can improve connector connection workability.

A wire harness according to the present disclosure is a wire harness including: an electric wire; a protector that stores part of the electric wire in a length direction; and a connector provided at one end of the electric wire led out from the protector, wherein: the a first lead-out port and a second lead-out port from each of which protector includes: the electric wire is led out; an electric wire fixing portion to which the electric wire is fixed; a main storage that is provided between the electric wire fixing portion and the first lead-out port and that stores the electric wire; and an extra length storage that is provided between the electric wire fixing portion and the second lead-out port and that is capable of storing an extra length of the electric wire, the connector is provided at the one end of the electric wire led out from the second lead-out port, the extra length storage includes a pillar, and the electric wire is stored in the extra length storage in a state of being wound around the pillar.

The wire harness according to the present disclosure can improve connector connection workability.

### BRIEF DESCRIPTION OF THE DRAWINGS

FIG. 1 is a schematic diagram showing a vehicle provided with a wire harness according to an embodiment;

FIG. 2 is a perspective view showing a first protector and its surroundings in the wire harness according to the embodiment;

FIG. 3 is a plan view showing the first protector with the cover open in the embodiment;

FIG. 4 is a side view of the first protector in the embodiment; and

FIG. 5 is a plan view of the first protector for explaining an electric wire installation state in the embodiment.

### DETAILED DESCRIPTION OF EMBODIMENTS

### Description of Embodiments of the Present Disclosure

First, embodiments of the present disclosure will be listed and described.

[1] A wire harness according to the present disclosure is a wire harness including: an electric wire; a protector that stores part of the electric wire in a length direction; and a connector provided at one end of the electric wire led out from the protector, wherein: the protector includes: a first lead-out port and a second lead-out port from each of which the electric wire is led out; an electric wire fixing portion to which the electric wire is fixed; a main storage that is provided between the electric wire fixing portion and the first lead-out port and that stores the electric wire; and an extra length storage that is provided between the electric wire fixing portion and the second lead-out port and that is capable of storing an extra length of the electric wire, the connector is provided at the one end of the electric wire led out from the second lead-out port, the extra length storage includes a pillar, and the electric wire is stored in the extra length storage in a state of being wound around the pillar.

With this configuration, the electric wire is wound around the pillar in the extra length storage of the protector, so that the extra length (slack) of the electric wire stored in the extra length storage can be absorbed. Hence, when connecting the connector provided at one end of the electric wire led out from the second lead-out port to a mating connector, the range of movement of the connector is increased by the absorption of the extra length of the electric wire in the extra length storage. This can improve connector connection workability.

[2] In [1], the main storage may be capable of absorbing the extra length of the electric wire.

With this configuration, the extra length of the electric wire can be absorbed in the main storage in accordance with the movement of the electric wire led out from the first lead-out port.

[3] In [1] or [2], a fixing direction of the electric wire at the electric wire fixing portion and a drawing direction in which the electric wire is drawn out from the second lead-out port may not match.

With this configuration, even when the fixing direction of the electric wire at the electric wire fixing portion and the drawing direction of the electric wire from the second lead-out port do not match, sharp bending of the electric wire from the electric wire fixing portion to the second lead-out port can be prevented as a result of the electric wire being wound around the pillar in the extra length storage. This can reduce the load on the connection part between the connector and the electric wire, the electric wire fixing portion, etc.

[4] In any of [1] to [3], the protector may include a partition wall that separates the main storage and the extra length storage.

With this configuration, the main storage and the extra length storage can be separated by the partition wall inside the protector.

[5] In any of [1] to [4], a dimension of the extra length storage is larger than a dimension of the main storage in a direction along a length of the pillar.

With this configuration, since the extra length storage is larger in the length direction of the pillar, the electric wire can be easily stored in a state of being wound around the pillar.

[6] In any of [1] to [5], the protector may include a protector body having an opening, and a cover that closes the opening, the pillar may extend from a bottom of the protector body toward the opening, and the cover may have a through hole through which a tip of the pillar passes.

With this configuration, the length of the pillar can be increased, so that the electric wire can be prevented from being caught between the tip of the pillar and the cover.

[7] In any of [1] to [6], the protector may include a support that supports the connector.

With this configuration, the protector includes the support that supports the connector. In such a case, the distance from the electric wire fixing portion to the connector tends to be short. If the electric wire from the electric wire fixing portion to the connector is routed with the shortest distance in the case where the distance from the electric wire fixing portion to the connector is short, it is difficult to handle the connector. In view of this, the configuration of [1] can be employed to further enhance the effect of improving connector connection workability.

### Details of Embodiments of the Present Disclosure

Specific examples of a wire harness according to the present disclosure will be described below, with reference to the drawings. In each drawing, part of the configuration may be exaggerated or simplified for convenience of explanation. In addition, the dimensional ratio of each part may be different among the drawings. In this specification, “perpendicular” means not only strictly perpendicular but also approximately perpendicular within the range in which the functions and effects in this embodiment are achieved.

### (Configuration of Wire Harness 10)

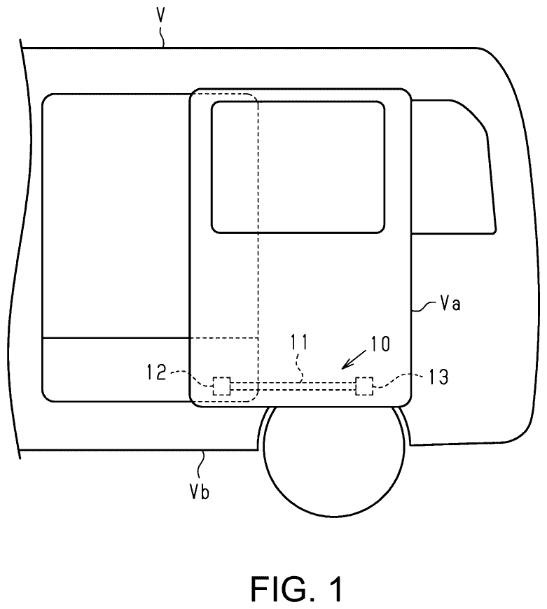

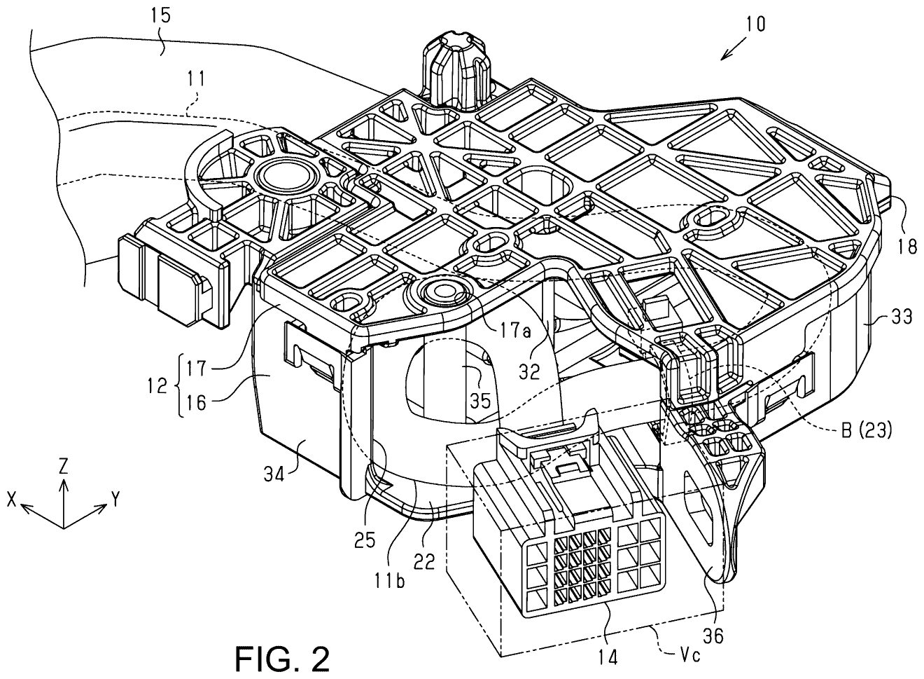

As shown in FIG. 1, a wire harness 10 according to this embodiment is used, for example, for a sliding door Va of a vehicle V. The wire harness 10 includes an electric wire 11, a first protector 12 provided at one end of the electric wire 11 in the length direction, and a second protector 13 provided at the other end of the electric wire 11 in the length direction. The first protector 12 and the second protector 13 each store part of the electric wire 11 in the length direction. The first protector 12 is fixed to, for example, a vehicle body Vb. The second protector 13 is fixed to, for example, the sliding door Va. The electric wire 11 and an exterior member 15 (see FIG. 2) surrounding the outer periphery of the electric wire 11 bend in accordance with the opening and closing operation of the sliding door Va.

As shown in FIG. 2, the wire harness 10 includes a connector 14 provided at one end of the electric wire 11 led out from the first protector 12. The connector 14 is connected to a mating connector Vc included in a wire harness provided on the vehicle body Vb, for example.

### (Configuration of First Protector 12)

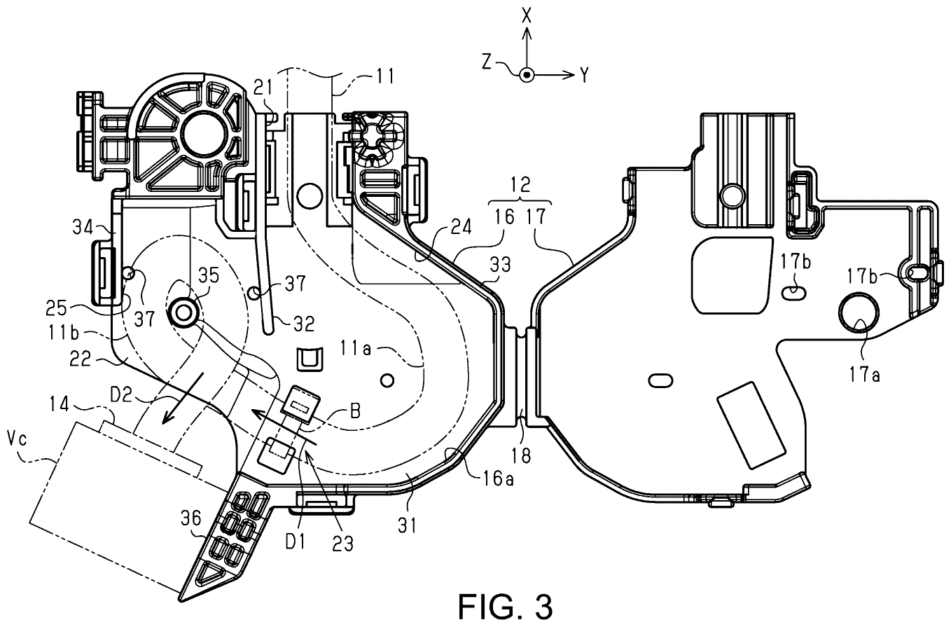

As shown in FIGS. 2 and 3, the first protector 12 includes a protector body 16 and a cover 17. The protector body 16 has an opening 16a in the height direction Z of the first protector 12. The cover 17 is fixed to the protector body 16 so as to close the opening 16a of the protector body 16. The cover 17 is formed integrally with the protector body 16 via a hinge portion 18, for example. The cover 17 is fixed to the vehicle body Vb, for example.

### (Configuration of Protector Body 16)

As shown in FIG. 3, the protector body 16 includes a first lead-out port 21 and a second lead-out port 22 through each of which the electric wire 11 is led out, and an electric wire fixing portion 23 to which the electric wire 11 is fixed. The protector body 16 also includes a main storage portion 24 (main storage) provided between the electric wire fixing portion 23 and the first lead-out port 21, and an extra length storage portion 25 (extra length storage) provided between the electric wire fixing portion 23 and the second lead-out port 22.

In the electric wire fixing portion 23, for example, the electric wire 11 is fixed to the bottom 31 of the protector body 16 by a band portion B such as a cable tie. The direction in which the electric wire 11 passes through the electric wire fixing portion 23 is referred to as the fixing direction D1 of the electric wire 11.

The electric wire 11 is stored in the main storage portion 24 and the extra length storage portion 25 in the protector body 16. The part of the electric wire 11 stored in the main storage portion 24 is a first electric wire part 11a, and the part of the electric wire 11 stored in the extra length storage portion 25 is a second electric wire part 11b.

The first electric wire part 11a is drawn out from the first lead-out port 21 in a first direction X perpendicular to the height direction Z, for example. The main storage portion 24 is a main part among the parts of the protector body 16 that store the electric wire 11. In detail, the length of the electric wire 11 stored in the main storage portion 24 (i.e. the length of the first electric wire part 11a) is longer than the length of the electric wire 11 stored in the extra length storage portion 25 (i.e. the length of the second electric wire part 11b). Moreover, the main storage portion 24 has a larger volume of space for storing the electric wire 11 than the extra length storage portion 25.

The protector body 16 includes the bottom 31, a partition wall 32, a first side wall 33, and a second side wall 34. The bottom 31 faces the cover 17 that closes the opening 16a in the height direction Z. The partition wall 32, the first side wall 33, and the second side wall 34 each extend from the bottom 31 in the height direction Z. The partition wall 32 separates the main storage portion 24 and the extra length storage portion 25. The partition wall 32 is provided between the first side wall 33 and the second side wall 34. The main storage portion 24 is formed between the first side wall 33 and the partition wall 32. The extra length storage portion 25 is formed between the second side wall 34 and the partition wall 32. The extra length storage portion 25 and the main storage portion 24 are arranged side by side in a second direction Y perpendicular to each of the height direction Z and the first direction X, for example.

In the protector body 16, the first side wall 33 forming the main storage portion 24 is shaped to bulge in the second direction Y. In detail, the main storage portion 24 partially bulges in a direction (second direction Y) perpendicular to the direction in which the electric wire 11 is drawn out from the first lead-out port 21. The main storage portion 24 is thus capable of absorbing the extra length of the first electric wire part 11a. Therefore, for example, the length of the first electric wire part 11a stored in the main storage portion 24 changes in accordance with the movement of the electric wire 11 that moves in response to the opening and closing operation of the sliding door Va.

### (Configuration of Extra Length Storage Portion 25)

The extra length storage portion 25 in the protector body 16 includes a pillar portion 35 (pillar) extending from the bottom 31 toward the opening 16a, for example. For example, the pillar portion 35 extends in the height direction Z. The cross-sectional shape of the pillar portion 35 perpendicular to the length direction of the pillar portion 35 is, for example, circular. The cover 17 has a through hole 17a through which the tip of the pillar portion 35 passes in the height direction Z, while covering the opening 16a of the protector body 16.

The second electric wire part 11b is wound around the pillar portion 35 once, for example, inside the extra length storage portion 25, and is drawn out from the second lead-out port 22 in a drawing direction D2. The drawing direction D2 is, for example, a direction perpendicular to the height direction Z. The drawing direction D2 and the fixing direction D1 of the electric wire 11 at the electric wire fixing portion 23 do not match. In other words, the fixing direction D1 and the drawing direction D2 are not parallel to each other. For example, the fixing direction D1 and the drawing direction D2 intersect each other. In this embodiment, the fixing direction D1 and the drawing direction D2 are approximately perpendicular to each other.

The connector 14 is provided at the end of the second electric wire part 11b led out from the second lead-out port 22. As a result of the second electric wire part 11b being wound around the pillar portion 35 in the extra length storage portion 25, the extra length of the second electric wire part 11b can be absorbed. This can increase the range of movement of the connector 14 connected to the end of the second electric wire part 11b.

The protector body 16 includes a support portion 36 (support) that supports the connector 14. The support portion 36 supports the connector 14 as a result of either the connector 14 or the mating connector Vc being fixed to the support portion 36. In this embodiment, for example, the mating connector Vc connected to the connector 14 is fixed to the support portion 36. As a result of the mating connector Vc being fixed to the support portion 36, the connector 14 connected to the mating connector Vc is supported by the support portion 36.

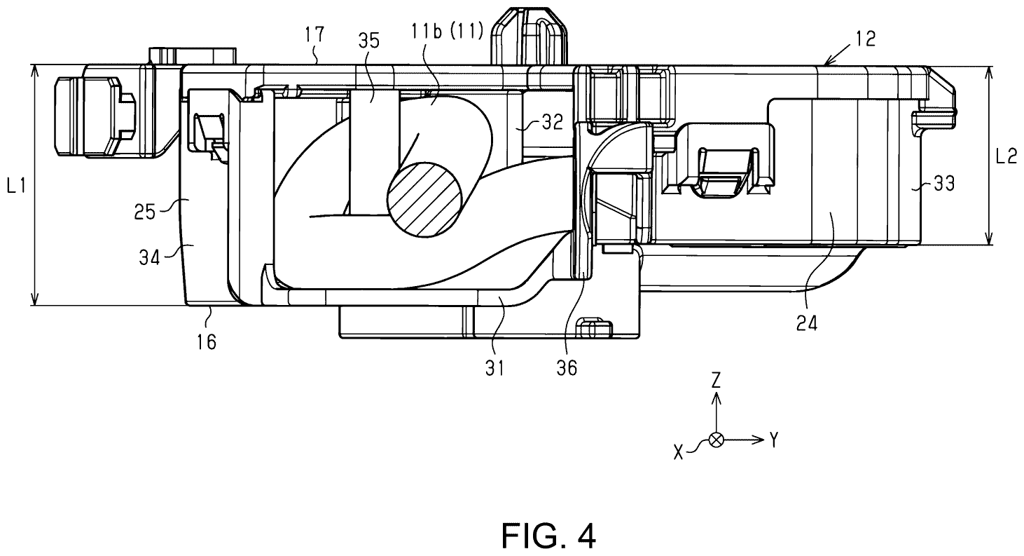

As shown in FIG. 4, the dimension L1 of the extra length storage portion 25 is larger than the dimension L2 of the main storage portion 24 in the height direction Z along the length of the pillar portion 35. The size of the extra length storage portion 25 in the length direction of the pillar portion 35 can thus be increased. This makes it easier to wind the second electric wire part 11b around the pillar portion 35 inside the extra length storage portion 25.

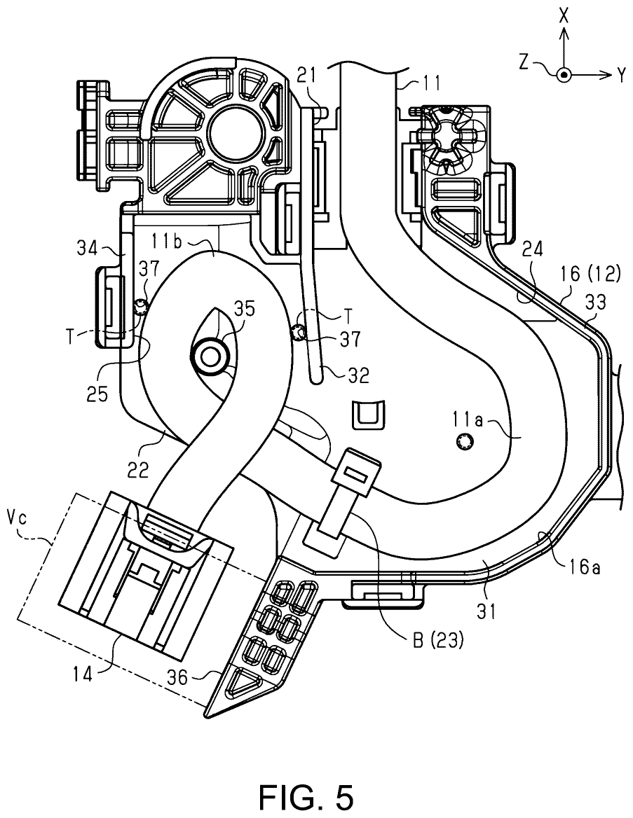

As shown in FIG. 5, the bottom 31 of the extra length storage portion 25 has a pair of jig holes 37. Each jig hole 37 is formed through the bottom 31 in the height direction Z. The jig holes 37 are located near the inner surfaces of the partition wall 32 and the second side wall 34 at the bottom 31. The cover 17 has cover-side jig holes 17b at positions corresponding to the respective jig holes 37 (see FIG. 3).

When storing the second electric wire part 11b of the electric wire 11 in the extra length storage portion 25, a jig pin T is inserted into each jig hole 37 from the back side of the bottom 31 and positioned inside the extra length storage portion 25. In this state, the second electric wire part 11b is wound around the pillar portion 35 so as to pass on the inner side of the jig pins T. After this, the cover 17 is closed, with each jig pin T inserted into the corresponding cover-side jig hole 17b. Thus, the second electric wire part 11b wound around the pillar portion 35 can be prevented from being caught between the cover 17 and the partition wall 32 and between the cover 17 and the second side wall 34. After the electric wire 11 is stored in the first protector 12, the jig pins T are removed from the first protector 12.

### Operations s According to this Embodiment

The operations according to this embodiment will be described below.

When mounting the wire harness 10 on the vehicle body Vb, the first protector 12 is fixed to the vehicle body Vb, and then the connector 14 at the tip of the second electric wire part 11b led out from the first protector 12 is connected to the mating connector Vc. The mating connector Vc is then fixed to the support portion 36 in the first protector 12. Here, since the second electric wire part 11b is wound around the pillar portion 35, the extra length of the electric wire 11 can be stored in the extra length storage portion 25. This eases inserting and removing the second electric wire part 11b to and from the second lead-out port 22, as a result of which the degree of freedom in handling the connector 14 is improved when connecting the connector 14 to the mating connector Vc and when fixing the mating connector Vc to the support portion 36.

Moreover, since the second electric wire part 11b is wound around the pillar portion 35 in the extra length storage portion 25, the second electric wire part 11b can be prevented from being forcibly bent (sharply bent). In this embodiment, the fixing direction D1 of the electric wire 11 at the electric wire fixing portion 23 and the drawing direction D2 in which the electric wire 11 is drawn out from the second lead-out port 22 do not match. Hence, there is a risk of the second electric wire part 11b being bent sharply if the path of the second electric wire part 11b from the electric wire fixing portion 23 to the connector 14 supported by the support portion 36 is set to the shortest distance. By winding the second electric wire part 11b around the pillar portion 35 as in this embodiment, the second electric wire part 11b can be prevented from being bent sharply even when the fixing direction D1 and the drawing direction D2 do not match.

### Effects According to this Embodiment

The effects according to this embodiment will be described below.

(1) The first protector 12 includes: the first lead-out port 21 and the second lead-out port 22 from each of which the electric wire 11 is led out; the electric wire fixing portion 23 to which the electric wire 11 is fixed; the main storage portion 24 that is provided between the electric wire fixing portion 23 and the first lead-out port 21 and stores the electric wire 11; and the extra length storage portion 25 that is provided between the electric wire fixing portion 23 and the second lead-out port 22 and is capable of storing an extra length of the electric wire 11. The connector 14 is provided at one end of the electric wire 11 led out from the second lead-out port 22. The extra length storage portion 25 includes the pillar portion 35. The electric wire 11 is stored in the extra length storage portion 25 in a state of being wound around the pillar portion 35. With this configuration, the electric wire 11 is wound around the pillar portion 35 in the extra length storage portion 25 of the first protector 12, so that the extra length of the electric wire 11 stored in the extra length storage portion 25 can be absorbed. Hence, when connecting the connector 14 provided at one end of the electric wire 11 led out from the second lead-out port 22 to a mating connector Vc, the range of movement of the connector 14 is increased by the absorption of the extra length of the electric wire 11 in the extra length storage portion 25. This can improve the workability of connecting the connector 14.

(2) The main storage portion 24 is capable of absorbing the extra length of the electric wire 11. With this configuration, it is possible to absorb the extra length of the electric wire 11 in the main storage portion 24 in accordance with the movement of the electric wire 11 led out from the first lead-out port 21.

(3) The fixing direction D1 of the electric wire 11 at the electric wire fixing portion 23 and the drawing direction D2 in which the electric wire 11 is drawn out from the second lead-out port 22 do not match. With this configuration, even when the fixing direction D1 of the electric wire 11 at the electric wire fixing portion 23 and the drawing direction D2 of the electric wire 11 from the second lead-out port 22 do not match, sharp bending of the electric wire 11 from the electric wire fixing portion 23 to the second lead-out port 22 can be prevented as a result of the electric wire 11 being wound around the pillar portion 35 in the extra length storage portion 25. This can reduce the load on the connection part between the connector 14 and the electric wire 11, the electric wire fixing portion 23, etc.

(4) The first protector 12 includes the partition wall 32 that separates the main storage portion 24 and the extra length storage portion 25. With this configuration, the main storage portion 24 and the extra length storage portion 25 can be separated by the partition wall 32 inside the first protector 12.

(5) The dimension L1 of the extra length storage portion 25 is larger than the dimension L2 of the main storage portion 24 in the direction along the length of the pillar portion 35. With this configuration, since the extra length storage portion 25 is larger in the length direction of the pillar portion 35, the electric wire 11 can be easily stored in a state of being wound around the pillar portion 35.

(6) The first protector 12 includes the protector body 16 having the opening 16a, and the cover 17 that closes the opening 16a. The pillar portion 35 extends from the bottom 31 of the protector body 16 toward the opening 16a. The cover 17 has a through hole 17a through which the tip of the pillar portion 35 passes. With this configuration, the length of the pillar portion 35 can be increased, so that the electric wire 11 can be prevented from being caught between the tip of the pillar portion 35 and the cover 17. Moreover, whether the electric wire 11 is caught between the tip of the pillar portion 35 and the cover 17 can be visually checked easily through the through hole 17a.

(7) The first protector 12 includes the support portion 36 that supports the connector 14. With this configuration, the first protector 12 includes the support portion 36 that supports the connector 14. In such a case, the distance from the electric wire fixing portion 23 to the connector 14 tends to be short. If the electric wire 11 from the electric wire fixing portion 23 to the connector 14 is routed with the shortest distance in the case where the distance from the electric wire fixing portion 23 to the connector 14 is short, it is difficult to handle the connector 14. In view of this, the configuration of (1) can be employed to further enhance the effect of improving the workability of connecting the connector 14.

### OTHER EMBODIMENTS

The following modifications can be made to the above embodiment. The above embodiment and the modifications described below may be combined unless they are technically inconsistent.
In the first protector 12, the support portion 36 that supports the connector 14 may be provided on the cover 17.
The connector 14 may be fixed to the support portion 36 in the first protector 12.
In the first protector 12, the support portion 36 that supports the connector 14 may be omitted, and either the connector 14 or the mating connector Vc may be fixed to the vehicle body Vb.
In the first protector 12 in the above embodiment, the pillar portion 35 may not pass through the cover 17.
Although the pillar portion 35 extends in the height direction Z in the above embodiment, the present disclosure is not limited to such, and the pillar portion 35 may not extend in the height direction Z. For example, the pillar portion 35 may extend in the first direction X or the second direction Y.

The configuration of the pillar portion 35, such as its shape, is not limited to the above embodiment and can be modified as appropriate.
In the extra length storage portion 25, the second electric wire part 11b may be wound around the pillar portion 35 two or more times.
Although the dimension L1 of the extra length storage portion 25 is larger than the dimension L2 of the main storage portion 24 in the above embodiment, the present disclosure is not limited to such, and the dimension L1 of the extra length storage portion 25 may be smaller than or equal to the dimension L2 of the main storage portion 24.
In the first protector 12 in the above embodiment, the fixing direction D1 of the electric wire 11 at the electric wire fixing portion 23 and the drawing direction D2 of the electric wire 11 from the second lead-out port 22 may match.
In the first protector 12 in the above embodiment, the main storage portion 24 may be incapable of absorbing the extra length of the electric wire 11 (first electric wire part 11a).
The cover 17 in the first protector 12 may be separated from the protector body 16 (i.e. s separate unit from the protector body 16).
Although the electric wire 11 is fixed to the protector body 16 by the band portion B such as a cable tie in the electric wire fixing portion 23 in the above embodiment, the electric wire 11 may be fixed to the protector body 16 by, for example, adhesive tape.
In the first protector 12 in the above embodiment, the partition wall 32 may be omitted.
Although the presently disclosed technology is applied to the first protector 12 in the above embodiment, the presently disclosed technology may be applied to, for example, the second protector 13 or a protector used in a wire harness other than the wire harness 10 for a sliding door.

The embodiments disclosed herein are illustrative in all respects, and the present disclosure is not limited to these examples. The scope of the present disclosure is defined by the claims and intended to include all modifications within the meaning and scope equivalent to the claims.

What is claimed is:

1. A wire harness comprising:
an electric wire;
a protector that stores part of the electric wire in a length direction; and
a connector provided at one end of the electric wire led out from the protector, wherein:
the protector includes:
a first lead-out port and a second lead-out port from each of which the electric wire is led out;
an electric wire fixing portion to which the electric wire is fixed;
a main storage that is provided between the electric wire fixing portion and the first lead-out port and that stores the electric wire; and
an extra length storage that is provided between the electric wire fixing portion and the second lead-out port and that is capable of storing an extra length of the electric wire,
the connector is provided at the one end of the electric wire led out from the second lead-out port,
the extra length storage includes a pillar, and
the electric wire is stored in the extra length storage in a state of being wound around the pillar.

2. The wire harness according to claim 1, wherein the main storage is capable of absorbing the extra length of the electric wire.

3. The wire harness according to claim 1, wherein a fixing direction of the electric wire at the electric wire fixing portion and a drawing direction in which the electric wire is drawn out from the second lead-out port do not match.

4. The wire harness according to claim 1, wherein the protector includes a partition wall that separates the main storage and the extra length storage.

5. The wire harness according to claim 1, wherein a dimension of the extra length storage is larger than a dimension of the main storage in a direction along a length of the pillar.

6. The wire harness according to claim 1, wherein:
the protector includes a protector body having an opening, and a cover that closes the opening,
the pillar extends from a bottom of the protector body toward the opening, and
the cover has a through hole through which a tip of the pillar passes.

7. The wire harness according to claim 1, wherein the protector includes a support that supports the connector.
